(19) United States
(12) Patent Application Publication
(10) Pub. No.: US 2026/0310544 A1
(43) Pub. Date: Oct. 8, 2026

(54) METHOD FOR ERROR HANDLING DURING THE NAVIGATION OF A MOBILE DEVICE

(71) Applicant: Robert Bosch GmbH, Stuttgart (DE)

(72) Inventors: Gerhard Kurz, Karlsruhe (DE); Matthias Holoch, Leonberg (DE); Peter Biber, Tuebingen (DE)

(21) Appl. No.: 19/480,942

(22) PCT Filed: May 8, 2024
(86) PCT No.: PCT/EP2024/062676

§ 371 Date: Nov. 3, 2025

(30) Foreign Application Priority Data
May 15, 2023 (DE) 10 2023 204 537.0

(51) Int. Cl. G06F 11/07

(52) U.S. Cl. CPC G06F 11/0793; G06F 11/0742

(57) ABSTRACT

A method for error handling during navigation of a mobile device. The mobile device moves in an environment, using SLAM-based localization. The method includes: repeatedly performing localization processes, wherein each process includes: providing device and environmental information, acquired from the device and/or the environment at least in part using sensors of the mobile device, creating a dataset based on the device and environmental information, and providing the dataset for use for the localization and/or navigation of the mobile device;

checking, during the localization processes, whether there is an error, and determining a dataset whose localization process contained an error to be a potentially erroneous dataset, and determining a dataset whose localization process did not contain an error to be a correct dataset. If a correct dataset is obtained after a potentially erroneous dataset: checking the potentially erroneous dataset to see whether it will be used further or not.

### FIELD

The present invention relates to a method for error handling during navigation of a mobile device, in particular of an at least partially automated vehicle or robot, to a system for data processing, to a computer program for carrying out the method, and to a mobile device.

### BACKGROUND INFORMATION

Mobile devices, such as at least partially automated moving vehicles or robots, typically move in an environment, in particular in an environment to be processed or in a work area, such as an apartment, in a garden, in a factory hall, or on the road, in the air or in water. One of the basic problems of such or also of other mobile devices is self-orientation, i.e., knowing what the environment looks like, i.e., in particular where obstacles or other objects are, and where (in absolute terms) the mobile device is. For this purpose, the mobile device can, for example, be equipped with various sensors, such as cameras, lidar sensors, radar sensors or inertial sensors, with the help of which the environment and the movement of the mobile device are, for example, sensed in two or three dimensions. This makes it possible for the mobile device to move locally, to detect obstacles in good time and to drive around them.

### SUMMARY

According to the present invention, a method for error handling during navigation of a mobile device, a system for data processing, and a computer program for carrying out the method, as well as a mobile device are provided. Advantageous example embodiments of the present invention are disclosed herein.

The present invention is generally concerned with mobile devices that move or at least can move in an environment or, for example, in a work area therein. Examples of such mobile devices (or mobile work equipment) are robots and/or drones and/or vehicles that move in a partially automated or (fully) automated manner (on land, in water or in the air). Examples of robots that can be considered are household robots such as cleaning robots (e.g., in the form of vacuum robots and/or mopping robots), floor-or street-cleaning devices, construction robots or robot lawn mowers, but also other so-called service robots, as well as vehicles that move in an at least partially automated manner, e. g., passenger transport vehicles or goods transport vehicles (also so-called industrial trucks, e.g. in warehouses), but also aircraft, such as so-called drones, or watercraft.

Such a mobile device has in particular an open-loop or closed-loop control unit and a drive unit for moving the mobile device so that the mobile device can be moved in the environment, e.g. along a movement path. For this purpose, navigation information can be determined, i.e., for example, specific instructions as to the direction in which the mobile device should travel in order to follow the movement path. These instructions can then be implemented via the open-loop or closed-loop control unit as well as via the drive unit. In general, this can be referred to as the navigation of the mobile device.

Moreover, a mobile device can comprise one or more sensors by means of which the environment or information in the environment can be captured. As mentioned, these sensors can, for example, be cameras, lidar sensors, radar sensors, or inertial measuring units (or inertial sensors) as well as a wheel odometry system, with the help of which the environment and the movement of the mobile device are captured, for example, in two or three dimensions. Depending on the type of mobile device, however, other or further sensors may also be provided.

The sensors can in particular be differentiated by different types of sensors, namely, so-called device sensors and so-called environmental sensors. By means of the device sensors, e.g., inertial measuring units and wheel odometry systems, device information, in particular device sensor data, can be captured and provided, which include information about a position and/or movement of the mobile device, i.e., for example, a speed, an acceleration, or a yaw rate of the mobile device. By means of the environmental sensors, e.g., cameras, lidar sensors, or radar sensors, environmental information, in particular environmental sensor data, can be captured and provided, which include information about the environment of the mobile device, i.e. for example, distances of the mobile device (or the sensor in question) to objects in the environment.

One way to determine a position and orientation, and thus for navigation as well, of such a mobile device is to use SLAM-based localization of the mobile device. SLAM (“simultaneous localization and mapping”) is a method in robotics in which a mobile device such as a robot can or must simultaneously create a map of its environment and estimate its spatial position within this map. It is thus used to detect obstacles and in this way supports autonomous navigation.

In SLAM, there are different approaches to displaying maps and positions. Conventional methods for SLAM are generally based on geometric information, such as nodes and edges. Nodes and edges are typically components of the SLAM graph. The nodes and edges in the SLAM graph may be designed in different ways; traditionally, the nodes correspond, for example, to the pose (position and orientation) of the mobile device or to particular environmental features at particular points in time, while the edges represent relative measurements between the mobile device and the environmental feature. SLAM graphs are described in more detail in, for example, Giorgio Grisetti, Rainer Kümmerle, Cyrill Stachniss, Wolfram Burgard, “A tutorial on graph-based SLAM,” IEEE Intelligent Transportation Systems Magazine, Vol. 2(4), pp. 31-42, 2010.

Based on such a SLAM graph, a map of the environment (environment map) in which the mobile device moves can be or will be determined. With each new dataset containing information about the environment and/or about the mobile device, which information is obtained from one or more sensors of the mobile device or is based thereon, the map (or the SLAM graph) can be expanded or updated.

During localization by means of SLAM, localization processes can be used. A localization process generally comprises the provision of device and environmental information, which has been acquired from the device and/or the environment at least in partly means of sensors of the mobile device, i.e. for example, the device and/or environmental information mentioned. Based on the device and environmental information, a dataset is created, which is then provided for use for the localization and/or navigation of the mobile device. For example, the environmental information or environmental sensor data can include a so-called point cloud, as provided by typical lidar sensors. The device information can then be used additionally to determine a position and orientation (collectively also referred to as a pose) of the mobile device for this point cloud.

Such a dataset obtained during a localization process can then be reconciled, as part of the localization, with a dataset obtained previously, i.e., during a preceding localization process. In this process, an attempt is made to bring the two datasets into agreement, at least within certain tolerances, in order thus to determine the movement or trajectory of the mobile device. This can also be referred to as a so-called match or scan match (the latter relates in particular to the case of a lidar sensor that collects the data as part of a scan). The reconciliation of a dataset with a (typically the immediately) preceding dataset is also called incremental localization.

Often, however, not every new dataset is added to the environment map mentioned; it is rather the case that a new dataset can only be added to the environment map at certain temporal and/or spatial intervals, for example. This keeps the amount of data smaller.

While localization by means of SLAM generally works very well under good conditions, a number of problems can arise in practice, for example with incremental localization, as has been shown. Such problems may be, for example, the loss of sensor data, wheel slip, so-called kidnapping (this means that the mobile device, usually a household robot, is picked up and set down again somewhere else), and occlusions of sensors (this in particular relates to the environmental sensors).

Simply further using the results of a localization process, in particular of an incremental localization process, in which an error has occurred may result in reduced accuracy (in the localization) or complete failure of the SLAM algorithm. Against this background, ways of dealing with potential errors in the navigation of a mobile device are proposed.

One embodiment of the present invention relates to a method for determining a position and orientation, and thus in particular also for the navigation, of a mobile device, wherein the mobile device moves or is intended to move in an environment, using SLAM-based localization.

In this case, data that include information about the position and/or movement of the mobile device are provided. This may be the device information already mentioned. The data were obtained from sources of different types. Suitable sources include Sensors, such as inertial measuring units and wheel odometry systems, but also other sources such as models or assumptions for a current velocity. The term “sources of different types” should in particular be understood to mean that there are multiple sources, i. e., for example, a sensor and a model or two different sensors, in particular even two sensors of different types.

According to an example embodiment of the present invention, it is provided that one or more partial aspects of the position and orientation (pose) are each assigned a set of sources from the sources of different types. In each set, the sources are in turn assigned a prespecified hierarchy of priorities. While the position and orientation can, for example, have six degrees of freedom, three translational degrees of freedom (position) and three rotational degrees of freedom (orientation), the term “partial aspect” is to be understood as a portion of these total degrees of freedom. However, it should be noted that not all six degrees of freedom necessarily have to be taken into account when it comes to position and orientation; for example, a vertical direction may be disregarded for a mobile device that only moves on one plane. The term “specified hierarchy of priorities” is then understood to mean that there is an order of the sources of the set according to which the sources are ordered.

A simple example is that the yaw angle (one rotational degree of freedom) as a partial aspect of the position and orientation is assigned a set of sources comprising an inertial measuring unit, the wheel odometry system, and a velocity model. The specified hierarchy of priorities may, for example, correspond to the order in which the three sources are mentioned here.

The availability of at least some of the sources of different types for the particular set (and thus for the particular partial aspect) is then checked. It is also determined whether the sources being checked are available or not. The term “availability of a source” can in particular be understood to mean whether the source provides its information at all or not, or whether a source provides, for example, inaccurate information, which should therefore not be used, for example.

Based on the data, the one position and orientation (i.e., in particular a so-called pose) of the mobile device are determined for the localization of the mobile device.

The one or at least one of the multiple partial aspects is determined based on the data of a selected source of the assigned set of sources. In the example mentioned, the yaw rate is thus determined, for example, either based on data of the inertial measuring unit, or based on data of the wheel odometry system, or based on data of the velocity model.

According to an example embodiment of the present invention, the selected source used is the source from the particular set of sources that has the highest priority according to the particular hierarchy, of the sources determined to be available. If all three sources are available in the example mentioned, the data of the inertial measuring unit will be used to determine the yaw rate based thereon. This also applies if at least the inertial measuring unit is available, but, for example, the wheel odometry system is not available. However, if the inertial measuring unit is not available but the wheel odometry system is available, the yaw rate will be determined based on the wheel odometry system.

This hierarchy allows the best possible available source to always be used so that sufficient accuracy is achieved even in the event of errors that lead to the unavailability of a source. However, if multiple sources were weighted in relation to each other, smaller inaccuracies could possibly be compensated for, but larger deviations from a faulty source would severely distort the result. The hierarchy or order of the sources in such a set can be defined, for example, depending on the need and situation or depending on the type of sources.

It should be noted that this only applies to one particular partial aspect, i.e., depending on the partial aspect, other sources and/or a different hierarchy may be provided. For example, two specific sensors can be provided for two different partial aspects, but with a different hierarchy, e.g. because one sensor provides more accurate values for one partial aspect than does the other sensor, and vice versa for the other partial aspect.

Likewise, determining whether a source is available or not also applies in particular to each partial aspect individually, or to the corresponding set of sources. For example, a certain sensor can be assigned to two different partial aspects but be considered to be unavailable in only one of them. This may be the case, for example, if this sensor provides a detected inaccuracy, and a sensor with more accurate data is assigned to one partial aspect but not to the other partial aspect. However, if the sensor is no longer providing any data, it will no longer be considered available for any of the partial aspects.

In one example embodiment of the present invention, the sources of different types comprise at least two of the following sources: one or more sensors, one or more position and/or motion models, and one or more position and/or movement presets. In particular, the sources of different types include an inertial measuring unit, a wheel odometry system, a target velocity, a constant velocity model, a constant velocity, a constant position model, and a constant position.

While the sensors, i. e., for example, the inertial measuring unit and the wheel odometry system, provide current measured values, the models can be used as a fallback solution. For example, if no sensor is available, it can be assumed that the mobile device is continuing to move at the most recently measured or determined velocity or is at the most recently determined position. If available, specifications can, for example, also be used, such as a target velocity, which does not necessarily have to be constant. This applies not only to positions and translational velocities, but also to orientations and rotational velocities.

In one example embodiment of the present invention, the one or one of the multiple partial aspects of the position and orientation comprises a position in the horizontal movement direction, i.e., for example, in the x and/or y direction (in the case of a Cartesian coordinate system). This partial aspect is then assigned the set of sources with the following specified hierarchy: the wheel odometry system, the target velocity, the constant velocity model, and the constant position model.

In one example embodiment of the present invention, the one or one of the multiple partial aspects of the position and orientation comprises a yaw angle. This partial aspect is assigned the set of sources with the following specified hierarchy: the inertial measuring unit, the wheel odometry system, the target velocity, the constant velocity model, and the constant position model.

In one example embodiment of the present invention, the one or one of the multiple partial aspects of the position and orientation comprises a pitch angle and/or a roll angle. This partial aspect is assigned to the set of sources with the following specified hierarchy: the inertial measuring unit, the constant velocity, and the constant position.

The three partial aspects mentioned above allow the position and orientation of the mobile device, and thus its navigation, to be determined as accurately as possible, even in the event of errors or other reasons why a source or sensor is not available. It should be noted that even if the proposed approach is applied to only one of the partial aspects, an improvement will have already been achieved.

In one example embodiment of the present invention, if two sources of different types, each comprising a sensor, are assigned to the same partial aspect of the position and orientation, in particular to the yaw angle, it will be determined that one of the two sources is not available should the corresponding data obtained from the two sources differ by more than a specified value. One of the two sources may comprise the inertial measuring unit, and the other of the two sources may comprise the wheel odometry system. In general, however, this may also be the case with two different sensors that can be used to determine a specific partial aspect. The two sensors can provide different types of data, which can however be used to determine the same partial aspect. Corresponding data must then be compared. While an inertial measuring unit such as a gyroscope is, for example, used to ascertain a rotation rate, based on which the yaw rate can then be determined (or which can be used as such), the wheel odometry system provides, for example, lengths of paths traveled by two wheels, which can be compared to determine the yaw rate based thereon.

Likewise, the two sensors do not have to be of different types; they may also be two sensors of the same type, e.g. two inertial measuring units which, for example, have a different quality or are arranged at different positions on the mobile device.

According to an example embodiment of the present invention, it is particularly preferred that, if the corresponding data from the source comprising the inertial measuring unit and from the source comprising the wheel odometry system differ by more than the specified value, it will be determined that the source comprising the wheel odometry system is not available. In other words, if the corresponding values provided by the inertial measuring unit and by the wheel odometry system, for example for the yaw rate, differ significantly, the inertial measuring unit will be given preference. It has been found that, at least for a short period of time, the inertial measuring unit provides more accurate measured values than does the wheel odometry system. If one of the two is faulty, the wheel odometry system is thus more likely to be faulty.

However, as already mentioned, this does not necessarily mean that the wheel odometry system is no longer being used for another partial aspect. For the horizontal position, the information from the wheel odometry system may still be more accurate than that from a model or the target velocity. However, depending on the degree of deviation between the values from the inertial measuring unit and the wheel odometry system, the wheel odometry system may also be determined to be not available, for example for the horizontal position.

In one example embodiment of the present invention, it is determined that a source, in particular a sensor, is not available if no data are or have been obtained from the source for at least a prespecified period of time, and/or if an error is detected for which it is specified that the source should not be available. In this way, further errors can be taken into account. If no data are obtained for a source or a sensor for at least a prespecified period of time, this source can be determined to be not available, as mentioned above, in particular for multiple partial aspects (if this source is assigned to multiple partial aspects). In this case, it can be assumed that the sensor or a communication connection is defective.

There are various possibilities for an error for which it has been prespecified that the source should not be available. For example, a so-called lift-up sensor can be provided on the mobile device, which sensor is triggered when the mobile device is lifted, in particular in the case of a household robot. This may, for example, be a contact sensor built into a wheel suspension of the mobile device. If lifting is detected, in particular as long as the mobile device is raised, the wheel odometry system can be determined to be unavailable because, without contact with the ground, the wheel odometry system will not provide reasonable values. However, such lifting as well as later setting down can also be detected by the inertial measuring unit, for example. Another error is, for example, a jump in the wheel odometry system or its data. So is a slip in the yaw rate, which can, for example, be detected by comparing the data or values from the inertial measuring unit and from the wheel odometry system (this can occur, for example, if the mobile device is moved sideways by an external force). All these errors indicate, for example, that the wheel odometry system should not be used, i.e. should be determined to be unavailable.

A further error is, for example, a standstill of the robot, which can be detected based on the inertial measuring unit and/or the wheel odometry system. The standstill can be used, for example, to reduce the computational load by avoiding unnecessary calculations and to eliminate the accumulation of small errors while the mobile device is stationary (e.g. due to a gradual drift of the inertial measuring unit).

In one example embodiment of the present invention, navigation information for the mobile device is also determined, namely, based on the position and orientation of the mobile device. This may then include, in particular, the consideration of further sensor data such as that of the lidar sensor, as already mentioned and as explained in more detail below.

One example embodiment of the present invention relates to a method for the localization, and thus in particular also for the navigation, of a mobile device, wherein the mobile device moves or is intended to move in an environment while using SLAM-based localization.

In a localization process, device information is provided, in particular device sensor data that have been acquired by means of sensors of the mobile device. The device information includes information about a position and/or movement of the mobile device. In addition, environmental sensor data acquired by means of sensors of the mobile device are provided. The environmental sensor data include information about the environment of the mobile device in order to obtain a current dataset. The device information and the environmental sensor data may be the information or data already explained in more detail above, i.e. for example information obtained from an inertial measuring unit and a wheel odometry system, as well as, for example, information obtained from a lidar sensor, a radar sensor or a camera.

The environmental sensor data may not all have been captured at the same time. This is the case, for example, with the lidar sensor, which generally scans the environment by means of a rotational or pivoting movement, which takes a certain period of time. However, the mobile device continues to move in the meantime. In this case, depending on the desired accuracy, a correction regarding the position and, if applicable, orientation of the mobile device, or other preprocessing can be carried out. This is explained in more detail below.

While a dataset of environmental sensor data, i.e., for example, a point cloud of a lidar sensor from a scan of the lidar sensor is typically available for a localization process, multiple datasets of device information or device sensor data are often available since the sampling frequency of an inertial measuring unit or of a wheel odometry system is usually higher than that of a lidar sensor.

Based on the device information, a preliminary position and orientation (i.e. a preliminary pose, also called initial pose) of the mobile device are then determined. For this purpose, the device information can be used, for example, to determine the position and orientation which the mobile device has relative to the preceding localization process. If there are multiple datasets of device information for a localization process, the one most recently obtained or an average of them can be used, for example.

This is followed by a first check (or a first checking process). This comprises a first reconciliation as to whether the current dataset with the preliminary position and orientation can be brought into agreement with one or more previously created datasets or with an existing environment map, preferably with a dataset provided in the preceding (i.e. in particular in the immediately preceding) localization process, according to at least one first reconciliation criterion. In the first checking process, a check result is then obtained; this check result may be positive if the datasets can be brought into agreement; otherwise, for example, negative.

In such a reconciliation, for example, an algorithm is used that works taking into account a cost function that compares the two datasets (measurements) to be reconciled, depending on the relative position between the measurements. An optimization algorithm can be used to determine the pose z that minimizes the cost function. The cost function may, for example, be a negative log-likelihood function if a probabilistic model is used, or another function that represents a measure of the quality of alignment between two datasets. It is possible for this process to take into account certain tolerances as to how precisely the two datasets must be consistent with each other in order to determine the reconciliation as positive. This can be taken into account in the first check with the mentioned, at least one first reconciliation criterion.

During the first reconciliation, starting from the preliminary or initial pose, an optimum for the pose is thus in particular found, i.e. an adjusted pose (or position and orientation in general), in particular if the first reconciliation or the first check is positive.

This is followed by a second check (or a second checking process). This comprises a second reconciliation as to whether the current dataset can be brought into agreement with one or more previously created datasets or with the existing environment map, preferably with the dataset provided in the preceding localization process, according to at least one second reconciliation criterion. Both the first and the second reconciliation can be a match or scan match as already mentioned.

During the second reconciliation, one or more parts of the device information (in particular from the current localization process, but possibly also from a preceding localization process) are taken into account, each with a weighting that depends on the check result. This can be done, for example, as a term (e.g. a penalty term) in the cost function (in the aforementioned optimization as part of the reconciliation), which can be selected depending on the check result. Alternatively or additionally, depending on the check result, the current dataset with the preliminary position and orientation or with a position and orientation obtained during the first reconciliation can be used in the second reconciliation. In particular if the first reconciliation is positive, the position and orientation obtained during the first reconciliation can be used since the position and orientation are then particularly accurate. However, if the first reconciliation was negative, it is useful to use the preliminary position and orientation since, for example, no better pose was found in the first reconciliation.

The first reconciliation and the second reconciliation can in principle be carried out in the same way, but possibly with changed weighting, e. g., as a term of the cost function, or via the pose from which the reconciliation is carried out. In this way, the current reliability of the device information can always be addressed as accurately and well as possible; for example, it can be taken into account to a greater or lesser extent. For example, during the first reconciliation, a standard weighting can be used for the device information, and the weighting in the second reconciliation may then deviate therefrom.

If the second reconciliation is positive, the dataset with the position and orientation obtained as part of the second reconciliation is provided for use for the localization and/or navigation of the mobile device. Due to the weighting in the second reconciliation, the position and orientation obtained, for example, during the optimization as part of the second reconciliation may be different from that in the first reconciliation.

The two reconciliations now make it possible to determine in the first reconciliation only the parameters for the second reconciliation, which is then the actual reconciliation (or scan match) and can then be used further as before. This allows a more efficient and accurate localization.

In one example embodiment of the present invention, the check result comprises a first check result if the first reconciliation is negative. In this case, for the first check result a first weighting is used, according to which in particular at least part of the device information is weighted higher than in the first reconciliation. This means that any deviation from the position and orientation from the device information can be kept as small as possible, i.e., any deviation is penalized more severely. This is advantageous, for example, if the environmental sensor data are less accurate; this is indicated by a negative first reconciliation. The device information can then be trusted more.

In one example embodiment of the present invention, the check result comprises a second check result if the first reconciliation is positive and if the first reconciliation is also underdetermined. The term “underdetermined reconciliation” is in particular understood to mean that the environment (from which the environmental sensor data, i.e. the dataset, originate) is featureless or has few features. For example, this may be the case with a long corridor. In such a case, it may be that not all degrees of freedom can be reliably estimated. For example, in the case of a lidar sensor and a corridor, it is easy to determine the distance to the walls of the corridor and the orientation, but it may be very difficult or impossible to estimate the movement along the direction of the corridor. In order to identify such cases, it is possible to consider, for example, the eigenvalues of the submatrix which relate to the position of the Hessian matrix of the optimization result from the first reconciliation. It can be determined whether the uncertainty is much greater in one direction than in the other by comparing the ratio of the two eigenvalues with a threshold value. This method makes it possible to determine cases of underdetermination in general and not just for the specific corridor case. For example, this approach can also detect a case in which the mobile device is close to a wall on one side and there is a large empty space on the other side. However, alternatively, it is also possible to use a detector or algorithm that explicitly detects the shape of the corridor in the sensor data.

In this case, for the second check result, a second weighting is used, according to which in particular at least part of the device information is weighted higher than in the first reconciliation. Due to the insufficient accuracy of the environmental sensor data, here the device information can be trusted more. The weighting can, for example, be the same for the first and second check results.

In one example embodiment of the present invention, the check result comprises a third check result if the first reconciliation is positive, if the first reconciliation is not underdetermined, and if the device sensor data have been determined to be unreliable. The device sensor data (or, where applicable, the device information in general) being determined to be unreliable is in particular understood to mean that the sensors in question provide incorrect values, for example, or should not be used for other reasons. For example, due to wheel slip, the value provided by the sensor in question (e.g. wheel odometry system) may be considered unreliable, and a fallback to constant velocity or position or another model as described above may be used. For this purpose, the pose determined from the device sensor data (preliminary pose or position and orientation) can be compared with the pose determined as part of the first reconciliation; it can then be checked whether the two poses differ by more than a predefined threshold value or are consistent within specified tolerances. For example, if a corridor has previously been detected, it can be assumed that this is due to the problem of insufficient reconciliation, and it can also be assumed that the device information is more likely to be correct.

In this case, for the third check result, a third weighting is used, according to which in particular at least part of the device information is weighted lower than in the first reconciliation.

Otherwise, it can be assumed that a good reconciliation has taken place and that proprioception is therefore more likely the cause of the problem.

In one example embodiment of the present invention, the check result comprises a fourth check result if the first reconciliation is positive, if the first reconciliation is not underdetermined, and if the device sensor data have not been determined to be unreliable. A weighting used in the first reconciliation, i.e. for example a standard weighting, is then used for the fourth check result. As a standard weighting or for the first reconciliation, it can be provided, for example, that the position and orientation are given little consideration and, for example, that the preliminary position and orientation are (in this case also) used (in the second reconciliation).

In one example embodiment of the present invention, it is also provided that the dataset provided in the preceding localization process (with the relevant position and orientation) is added to the existing environment map if at least one update criterion is present, which in particular includes a detected error in the (current) localization process. Unlike the usual criteria already mentioned, according to which a dataset is added to the environment map, in the case of an error, the dataset obtained therefrom, which is correct, is added so as to thus achieve a final update.

The at least one update criterion preferably comprises at least one of the following update criteria. If the second reconciliation is negative, in particular if, in addition, the second reconciliation in the preceding localization process was positive. If the device sensor data have been determined to be unreliable, in particular if, in addition, the device sensor data in the preceding localization process had not been determined to be unreliable. If the first reconciliation is underdetermined, in particular if the first reconciliation in the preceding localization process was not underdetermined. These are cases in which different weightings can be used, as explained above. It may also be included if the mobile device was placed on a surface during the preceding localization process (and, in this case, lifted even earlier). This can be detected, for example, via the lift-up sensor mentioned above. In this case, it can be assumed that the device sensor data are incorrect. It may also include that the environmental sensor data were not obtained or provided at least temporarily during the localization process. Here, too, the data are assumed to be unreliable. Furthermore, the update criteria already mentioned, such as the elapse of a certain period of time, a certain distance traveled, or a number of scans carried out (datasets obtained) can also be used.

In one example embodiment of the present invention, adding the dataset provided in the preceding localization process, to the existing environment map comprises checking whether a difference between a position and orientation of the mobile device, determined on the basis of the device information, in the dataset being added and the position and orientation of the mobile device in a dataset most recently added to the environment map is within a specified tolerance. This can also be referred to as a so-called refinement match. In this way, it can be checked whether the position and orientation from the device sensor data include a drift which is too small in the incremental localizations to be considered an error. If this difference is within the tolerance, the dataset can be added; otherwise, for example, not.

In one example embodiment of the present invention, navigation information for the mobile device is also determined, namely, based on the provided dataset with the relevant position and orientation of the mobile device.

One example embodiment of the present invention relates to a method for error handling during the navigation of a mobile device, wherein the mobile device moves or is intended to move in an environment, while using SLAM-based localization. In this case, localization processes are carried out repeatedly.

In each localization process, device and environmental information is provided, which has been acquired from the device and/or the environment at least in part by means of sensors of the mobile device. This can be the device sensor data and environmental sensor data already mentioned, but possibly also data obtained on the basis of models. A dataset is then created, namely, based on the device and environmental information. The dataset is provided for use for the localization and/or navigation of the mobile device. In particular, all further processing can be included in a localization process, as explained above, for example.

However, during the localization processes, it is checked whether there is an error (or a problem). A dataset whose localization process contained an error is then determined to be (or marked, for example, as) a potentially erroneous dataset, and a dataset whose localization process did not contain an error is determined to be a correct dataset.

If a correct dataset is then obtained after a potentially erroneous dataset, the potentially erroneous dataset is checked to see whether it will be used further or not. In this way, the decision on how to deal with the error is shifted to the very end, when the actual processing of the dataset in the individual (incremental) localization process has already been completed. If, for example, it is then determined that the error was not serious, the data can still be used.

In one example embodiment of the present invention, checking the potentially erroneous dataset comprises checking whether the correct dataset can be brought into agreement (i.e. is consistent) with one or more correct datasets obtained before the potentially erroneous dataset or with an existing environment map according to at least one first reconciliation criterion in order to obtain a first check result. This can be done, for example, as part of a reconciliation or scan match, as explained above, with the difference that one of the datasets to be reconciled here is considered potentially erroneous.

In one example embodiment of the present invention, if the first check result is negative, i.e., if the datasets cannot be brought into agreement, the potentially erroneous dataset is determined to be an erroneous dataset. In this case, the dataset is then no longer used.

In one example embodiment of the present invention, if the first check result is positive and if the potentially erroneous dataset is consistent with the dataset obtained directly before the potentially erroneous dataset, according to at least one second reconciliation criterion, the potentially erroneous dataset is determined to be a correct dataset. This means that the reconciliation carried out as part of the incremental localization was positive, i.e., the error was at most minor or had little to no influence. The dataset can therefore be used further, and no further measures have to be taken.

Furthermore, if the potentially erroneous dataset is not consistent with the dataset obtained immediately before the potentially erroneous dataset, according to the at least one second reconciliation criterion, the potentially erroneous dataset is preferably determined to be an erroneous dataset. In this case, the error was so large that the reconciliation during the incremental localization was not successful, even if the reconciliation between correct datasets was successful, so that the data nevertheless should then no longer be used.

In one example embodiment of the present invention, it is furthermore provided to create a new environment map based on the correct dataset obtained after the dataset determined to be erroneous. In particular, the erroneous dataset is not used in this process. This new environment map can then be combined with the existing environment map, for example. In the event that the first check result was positive but the dataset nevertheless was ultimately incorrect, these environment maps can also be combined immediately since a sufficiently accurate reconciliation was available.

In one example embodiment of the present invention, it is furthermore provided that correct datasets are added to the existing environment map if at least one update criterion is present. This update criterion can be one of the following: The dataset obtained after the correct dataset was determined to be erroneous. Since the last time a correct dataset was added to the existing environment map, the mobile device has traveled a given distance: A specified period of time has passed since the last time a correct dataset was added to the existing environment map. A predetermined number of correct datasets has been obtained since the last time a correct dataset was added to the existing environment map. This ensures, in particular with the first criterion mentioned, that a correct dataset is used to update the map before a new map is possibly generated.

In one example embodiment of the present invention, it is determined that an error has occurred during a localization process if at least one of the following error criteria is met: Sensor data of a sensor of the mobile device are determined to be erroneous, e.g., because the sensor provides data that differ from other sensors or is no longer providing any data at all. An error can also be assumed if it is determined on the basis of the sensor data that the mobile device has been lifted. This can be done, for example, on the basis of the lift-up sensor mentioned above, or by using the inertial measuring unit. An error can also be assumed if it is determined on the basis of the sensor data that the mobile device has been moved by an external force, in particular horizontally. This can be determined, for example, by using the inertial measuring unit, or possibly also with the wheel odometry system. Likewise, an error can be detected if the difference between the position and/or orientation of the mobile device, determined on the basis of the device sensor data, in the correct dataset being added and in a correct dataset most recently added to the environment map is not within a specified tolerance. This means that the aforementioned refinement match was not successful.

In one example embodiment of the present invention, navigation information for the mobile device is also determined, namely on the basis of the datasets provided.

A system according to the present invention for data processing or a computing unit, e.g., a control device or a control unit of a mobile device, or a server or other computer, is configured, in particular in terms of programming, to carry out a method according to the present invention, e. g. in one of the described embodiments.

The present invention also relates to a mobile device that has such a system for data processing or that is configured to obtain navigation information determined as described above. The mobile device preferably also comprises a drive system and an open-loop or closed-loop control unit for moving the mobile device according to the navigation information. The mobile device is preferably also configured to carry out processing; in particular, the mobile device may be one as described above, i. e., for example, a cleaning robot or a robot lawn mower.

Furthermore, the implementation of a method according to the present invention in the form of a computer program or computer program product having program code for carrying out all the method steps is advantageous because it is particularly low-cost, in particular if an executing control unit is also used for further tasks and is therefore present anyway. Finally, a machine-readable storage medium is provided with a computer program as described above stored thereon. Suitable storage media or data carriers for providing the computer program are, in particular, magnetic, optical, and electric storage media, such as hard disks, flash memory, EEPROMs, DVDs, and others. It is also possible to download a program via computer networks (internet, intranet, etc.) . Such a download can be wired or wireless (e.g., via a WLAN network or a 3G, 4G, 5G or 6G connection, etc.).

Further advantages and embodiments of the present invention can be found in the description herein and the figures.

The present invention is illustrated schematically in the figures on the basis of an example embodiment and is described below with reference to the figures.

### BRIEF DESCRIPTION OF THE DRAWINGS

FIG. 1 schematically shows a mobile device in an environment to explain an example embodiment the present invention.

FIG. 2 schematically shows a sequence of an example method in order to explain the present invention.

FIG. 3 schematically shows a further sequence of an example method in order to explain the present invention.

FIG. 4 schematically shows a further sequence of an example method in order to explain the present invention.

FIG. 5 schematically shows a further sequence of an example method in order to explain the present invention.

### DETAILED DESCRIPTION OF EXAMPLE EMBODIMENTS

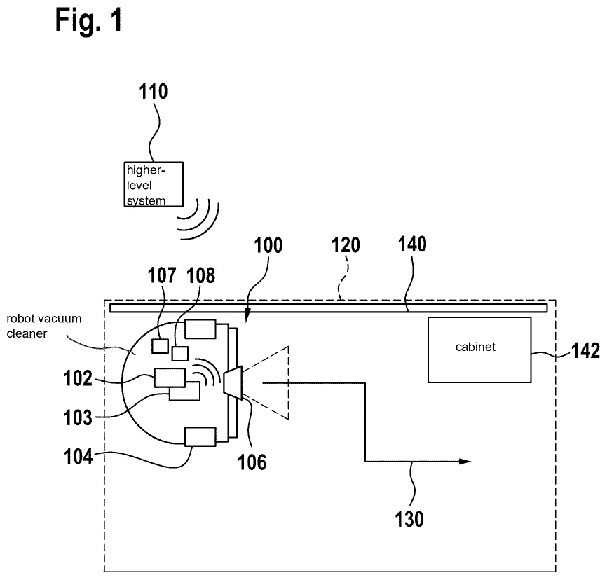

FIG. 1 schematically and by way of example shows a mobile device 100 in an environment 120, in particular in a work area, in order to explain the present invention. The mobile device 100 is, by way of example, a robot vacuum cleaner with an open-loop or closed-loop control unit 102 and a drive unit 104 (with wheels) for moving the robot vacuum cleaner 100, e.g., along a movement path 130. Furthermore, the robot vacuum cleaner 100 has, by way of example, a sensor 106 designed as a lidar sensor with a detection range. For better illustration, here the detection range has been chosen relatively small; in practice, however, the detection range can also be up to 360° (e.g. at least 180° or at least 270°). The environment 120 can be captured by means of the sensor 106, i.e., environmental sensor data or environmental information in general can be generated therewith.

Furthermore, the robot vacuum cleaner 100 has, by way of example, a sensor 107 designed as an inertial measuring unit and a sensor 108 designed as a wheel odometry system. The wheel odometry system can in particular be divided between the two wheels of the drive unit 104, although this is not shown here for the sake of simplicity. By means of the sensors 107 and 108, information about a position and/or movement of the robot vacuum cleaner 100 can be acquired, i.e., device sensor data or device information in general can be generated therewith.

Furthermore, the robot vacuum cleaner 100 has a computing unit 103, e.g. a control device, by means of which data can be exchanged with a higher-level system 110, e.g. via an indicated radio link. In the system 110, for example, movement paths (or navigation information in general) can be determined, which are then transmitted to the system 103 in the robot vacuum cleaner 100, which should then follow said movement paths. However, it can also be provided that a movement path (or navigation information in general) is determined in the system 103 itself or otherwise obtained there. Instead of a movement path or the navigation information, the system 103 can also obtain, for example, control information which has been determined on the basis of a movement path or the navigation information and according to which the open-loop or closed-loop control unit 102 can move the robot vacuum cleaner 100 via the drive unit 104 in order to follow a movement path. The movement path 130 is indicated here only by way of example.

The robot vacuum cleaner 100 is intended to move or navigate independently in the environment 120 and, for example, clean a floor. Furthermore, multiple different objects or obstacles are shown in the environment by way of example, namely, a wall 140 and a cabinet 142.

Although the present invention is in particular explained, here and below, using the example of the robot vacuum cleaner, this also applies to other mobile devices, such as robot lawn mowers or other self-propelled vehicles. Instead of the lidar sensor, a camera or a radar sensor can also be provided, for example. Furthermore, the robot vacuum cleaner or the mobile device in general can also comprise further sensors, such as the lift-up sensor already mentioned.

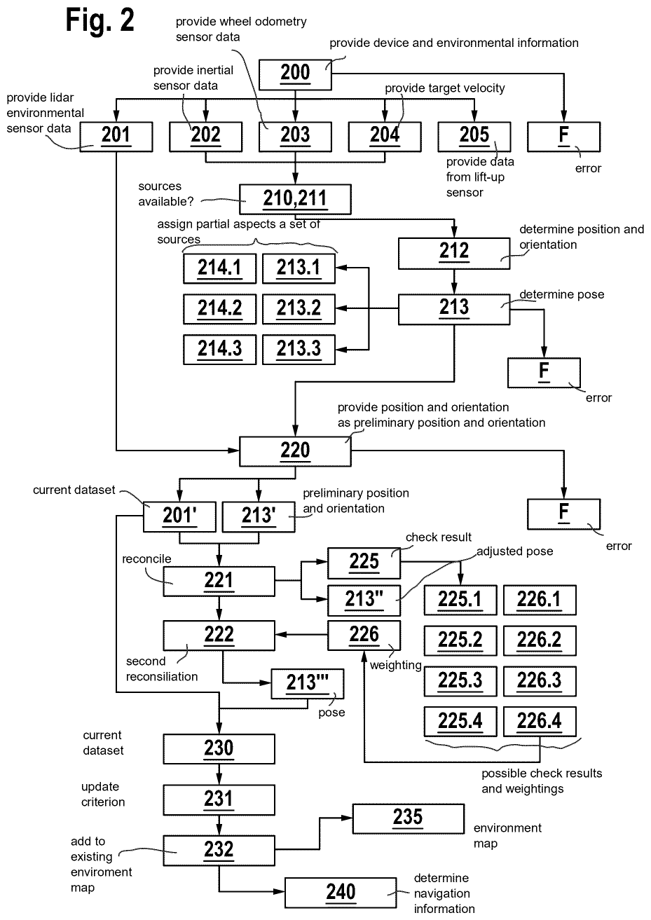

FIG. 2 schematically shows a sequence of a method in order to explain various embodiments. The method is generally used for the navigation of a mobile device, such as the robot vacuum cleaner according to FIG. 1, which may also include a determination of the position and orientation of the mobile device as well as its localization. Error handling may also be carried out in the process. The method described below includes various individual aspects or embodiments that can also be used individually.

First of all, in a step 200, device and environmental information is provided. This information can in particular include environmental sensor data 201 from, for example, the lidar sensor, as well as device sensor data 202 from the inertial measuring unit and device sensor data 203 from the wheel odometry system. These data may furthermore include device information 204, such as a target velocity of the robot vacuum cleaner. Likewise, data or information 205 can be provided by, for example, the lift-up sensor (possibly also as part of the device information). In general, all relevant information and sensor data can be provided in step 200.

This shows that device information comes from sources of different types, namely, from the inertial measuring unit, from the wheel odometry system, and from a target velocity in the example shown.

When providing this information and, if necessary, also when collecting sensor data and/or other information as required in the process, it can also be checked whether there is an error F, i.e. for example, a sensor is not providing any data.

Based on this device information or the corresponding data, the position and orientation of the mobile device for the localization of the mobile device are determined in a step 212. The position and orientation 213 (hereinafter also referred to as the pose) can be determined, for example, relative to a most recently determined pose.

For example, multiple partial aspects of the pose are each assigned a set of sources from sources of different types. For example, a partial aspect 213.1 comprises a position in the horizontal movement direction to which is assigned the set 214.1 of sources with the following specified hierarchy: the wheel odometry system, the target velocity, a constant velocity model, and a constant position model.

For example, a partial aspect 213.2 comprises a yaw angle to which is assigned the set 214.2 of sources with the following specified hierarchy: the inertial measuring unit, the wheel odometry system, the target velocity, the constant velocity model, and the constant position model.

For example, a partial aspect 213.3 comprises a pitch angle and/or a roll angle to which is assigned the set 214.3 of sources with the following specified hierarchy: the inertial measuring unit, a constant velocity, and a constant position.

However, before step 212, in a step 210, it is checked whether the sources of different types for the corresponding set of sources are available. For example, a source is not available if no data are or have been obtained from the source for at least a prespecified period of time and/or if an error is detected for which it has been prespecified that the source is not to be available; the latter may include, for example, the lift-up sensor indicating that the mobile device has been lifted, which may result in the wheel odometry system being considered unavailable.

It may also be the case, for example, that the corresponding data obtained from the inertial measuring unit and from the wheel odometry system differ by more than a prespecified value. It can then be determined that the wheel odometry system or the source comprising the wheel odometry system is unavailable. In general, in a step 211, it can be determined for each source whether the source is available or not.

In steps 210, 211, 212, it can also be checked whether there is an error F, i.e. for example, a sensor is not providing any data. The case in which a sensor or another source is determined to be unavailable can also be considered an error.

In step 212, the partial aspects are determined individually, namely, in each case based on the source that has the highest priority in the corresponding set, whereby a position and orientation (pose) are ultimately obtained. It should be noted that six different degrees of freedom do not necessarily have to be determined here; for example, depending on the situation, a vertical position may not be necessary. Based on the position and orientation of the mobile device, navigation information for the mobile device can then be determined.

It should be mentioned that, for example, not only the position and orientation can be treated separately, but a distinction can also be made between the yaw angle (which can be determined by means of wheel odometry systems and target velocity but can usually only be measured relative to the starting position) and the roll/pitch angles (which, for example, can only be measured with the inertial measuring unit but are measured in an absolute coordinate system with respect to the gravity vector).

As an alternative solution, as mentioned above, it is, for example, possible to use the constant velocity model or the constant position model, which assumes that the mobile device moves at a constant velocity and rotates at a constant angular rate, or does not move and does not rotate at all. For example, the constant velocity may not be available at the first time step since it is not yet possible to estimate a velocity. In addition, the output of the constant velocity model should be compared with the maximum velocity achievable by the particular mobile device and should be discarded if this velocity is significantly exceeded, since this may indicate an incorrect velocity estimate. The constant position model, on the other hand, is always available as a last resort.

For calculating the pose or trajectory (pose relative to the last pose), the start and end time stamps of the time interval of interest as well as all time stamps within the interval associated with a sensor measurement can be taken into account. It is not necessary to assume that all sensors have the same sampling rate or that their measurements are carried out synchronously. The data of all sensors for all timestamps can therefore be interpolated on the basis of adjacent measurements, e.g. by linear or spline-based interpolation. In this way, a trajectory with high temporal resolution can be obtained.

If a lidar sensor is used to collect the environmental sensor data, these environmental sensor data (or the lidar scan) can first be preprocessed. One of the problems with rotating lidar sensors can be that the points of a lidar scan are not all collected at the same time, resulting in scan distortion. The trajectory from the preceding step can therefore be used to calculate the position of all scan points as if they had been recorded at the same time, e.g. at the beginning or at the end of the scan interval (distortion-corrected).

If the provided trajectory cannot be used for the distortion-corrected calculation (e.g. because a fallback to a constant position had taken place), a modified scan matcher can, for example, be used instead, which carries out distortion correction during the scan matching.

In addition to the step of distortion-corrected representation, in this step dynamic objects can also already be detected in the measurement or processing of the environmental sensor data. If a lidar sensor is used, an algorithm for detecting changes can be used. For distinguishing between static and dynamic objects, the current measurement can be compared with previous measurement(s) or a local map (the environment map). By removing dynamic objects, such as animals, people, moving doors, etc., their impact on the tracking algorithm can be eliminated or at least reduced. If the pose from the preceding step is not sufficiently accurate for this purpose due to the previously identified problems, dynamic object detection can be omitted in order to avoid erroneous removal of static parts of the measurement.

If a two-dimensional environmental sensor such as a 2D lidar is used, it may also be advantageous to carry out leveling. When leveling, the roll/pitch angle of the mobile device can be used to rotate the measurement (e.g. the point cloud) such that it is parallel to a global, gravity-aligned coordinate system. This makes it possible to use 2D matching algorithms even if the mobile device is tilted, e.g. due to uneven floor. It may also be advantageous to filter the observed points by their height. In 2D SLAM systems, observing the floor or the ceiling can be problematic since this results in unstable measurements that move depending on the angle of the sensor and should therefore not be used in the matching algorithm. In order to avoid such problems, points that are on or below the floor can be filtered on the basis of their height after leveling. It is possible to be even more restrictive and only allow points that are within a vertical range of a few centimeters around the mounting height of the sensor. This avoids accidental detection of structures that are at a different height and that are normally not visible to the sensor.

Next, based on the determined position and orientation 213 as well as on the environmental sensor data 201, a dataset is to be determined, which is used for the further localization and/or navigation of the mobile device, in particular, if necessary, also for the expansion of an environment map. For this purpose, in a step 220, the position and orientation 213 are to be provided as a preliminary position and orientation 213′, and the environmental sensor data 201 are to be provided as a current dataset 201′.

In a step 221, a first check is carried out, comprising a first reconciliation as to whether the current dataset 201′ with the preliminary position and orientation 213′ (i.e. if the environmental sensor data are linked to the preliminary pose) can be brought into agreement with one or more previously created datasets or with an existing environment map, e.g. a dataset provided in the preceding localization process, according to at least one first reconciliation criterion. The term “localization process” is understood to mean a process in which a dataset with a pose is determined and then used for further processing, e.g. is added to an environment map. A check result 225 is obtained.

The first check or first reconciliation is, for example, an optimization process in which, starting from the current dataset with the preliminary pose, an attempt is made to bring the current dataset into agreement with the preceding dataset mentioned above. For example, an adjusted pose 213″ can be obtained in this process. This is, for example, a so-called scan match.

After this, in a step 222, a second check is carried out, namely, taking into account the check result 225. This comprises a second reconciliation as to whether the current dataset 201′ can be brought into agreement with one or more previously created datasets or with the existing environment map, preferably with the dataset provided in the preceding localization process, according to at least one second reconciliation criterion.

However, in the second reconciliation, one or more parts of the device information are taken into account, each with a weighting 226 dependent on the check result 225. Alternatively or additionally, depending on the check result 225, the current dataset 201′ with the preliminary position and orientation (pose) 213′ or with the position and orientation 213″ obtained during the first reconciliation is used. In the context of the example, four possible check results 225.1, 225.2, 225.3, 225.4, which are explained in more detail below, are considered by way of example.

The second check or second reconciliation is, for example, also an optimization process in which, starting from the current dataset with the preliminary pose or the pose obtained in the first reconciliation, an attempt is made to bring the current dataset into agreement with the preceding dataset mentioned above. In this case, for example, a further adjusted pose 213″ can then be obtained. This is also a so-called scan match, in particular a second scan match

If the second reconciliation is positive, in a step 230, the current dataset 201′ with the pose 213′″ (obtained in the second reconciliation) is provided for use for the localization and/or navigation of the mobile device.

An error F can also occur in the context of these two checking or reconciliation processes (here, by way of example, marked at step 200).

In a step 340, for example, navigation information for the mobile device can then be determined in order that the mobile device will be able to navigate or move.

In order to track the movement of the mobile device, the scan matches mentioned can be used. A matching algorithm, e. g. a scan-matching algorithm such as iterative closest point (ICP), normal distribution transform (NDT), correlative scan matching, or a visual feature-matching algorithm can be used here. These matching algorithms work taking into account a cost function that compares the two measurements (datasets) to be reconciled, depending on the relative position between the measurements. Depending on the application, these measurements can be point clouds (in the case of a lidar sensor), camera images, radar measurements, etc.

For example, an optimization algorithm is used to determine the position that minimizes the cost function. The cost function may, for example, be a negative log-likelihood function if a probabilistic model is used, or any other function that represents a measure of the quality of alignment between two measurements. Generally, these optimization algorithms start with a first estimate, which is then refined over time, e.g. by means of a Newton iteration. Since the cost function cannot be convex, the resulting pose after convergence depends on a good choice of the initial pose. For this purpose, the pose determined on the basis of the device sensor data (preliminary pose) could in principle be used to increase the probability that the algorithm converges to the global optimum rather than to a local optimum that is far from the true value.

In order to introduce prior knowledge about the relative transformation (i.e. between two poses), it is possible to extend the cost function by adding a term that describes the deviation from the previous pose. By introducing an additional term, the shape of the cost function changes and its minimum is shifted toward the previous position since deviations from the previous position are penalized with higher costs, even if the agreement itself is better. In this way, weights can thus be taken into account in a scan match in order, for example, to allow device sensor data to flow in more or less strongly.

The main problem with such an approach is the choice of the weighting of the term for the device sensor data or the pose determined therewith. If the weighting is too large, the result will depend only on the pose and ignores information from the measurements (environmental sensor data, e.g. from the lidar sensor); if the weighting is too small, the pose will be ignored. It has now been shown that a good weighting of the pose depends on the particular circumstances and can be adjusted accordingly. If the pose comes from very reliable sensors that are currently not affected by problems, their weighting should be chosen large. However, if the pose comes from inaccurate sensors or these sensors are currently affected by problems, the weighting should be chosen significantly smaller.

In order to obtain a good choice of parameters for the matching algorithm, it is thus proposed to perform two scan matches. The first reconciliation is used to gain insight into the current situation, and its results are used to adjust the parameters of the second reconciliation. The second reconciliation is then carried out with the adjusted parameters in order to obtain the actual result. A particularly relevant case that can be identified on the basis of the first reconciliation is the case of a featureless environment, such as a corridor, where the current situation is underdetermined, i.e. not all degrees of freedom can be reliably estimated. For example, in the case of a lidar sensor and a corridor, it is easy to estimate the distance to the walls of the corridor and the orientation, but it is very difficult or impossible to estimate the movement along the direction of the corridor.

In order to identify such cases, it is possible to consider, for example, the eigenvalues of the submatrix which relates to the position of the Hessian matrix of the optimization result from the first reconciliation. It is determined whether the uncertainty is much larger in one direction than in the other by comparing the ratio of the two eigenvalues with a threshold value. This method not only identifies specific corridor cases but also cases in which there is another underdetermination. For example, this approach also identifies the case in which the mobile device is close to a wall on one side and there is a large empty space on the other side. Alternatively, it is also possible to consider a detector that explicitly detects the shape of the corridor in the sensor data.

A further problem that can be identified by means of the first reconciliation is that the pose determination, i.e. the device sensor data, is unreliable, e. g. due to wheel slip that was not detected by the wheel slip yaw detector (e.g. by means of the wheel odometry system) due to a fallback to constant velocity/position or for other reasons. For this purpose, the pose determined on the basis of the device sensor data is compared with the result of the first reconciliation and it is checked whether the two poses differ by more than a predefined threshold value. If a corridor has been previously detected, it can be assumed that this is due to the problem of insufficient reconciliation, and it can be assumed that the pose is more likely to be correct. Otherwise, it can be assumed that there has been a good reconciliation and that the device sensor data are thus more likely the cause of the problem. In the latter case, the device sensor data can be regarded as unreliable.

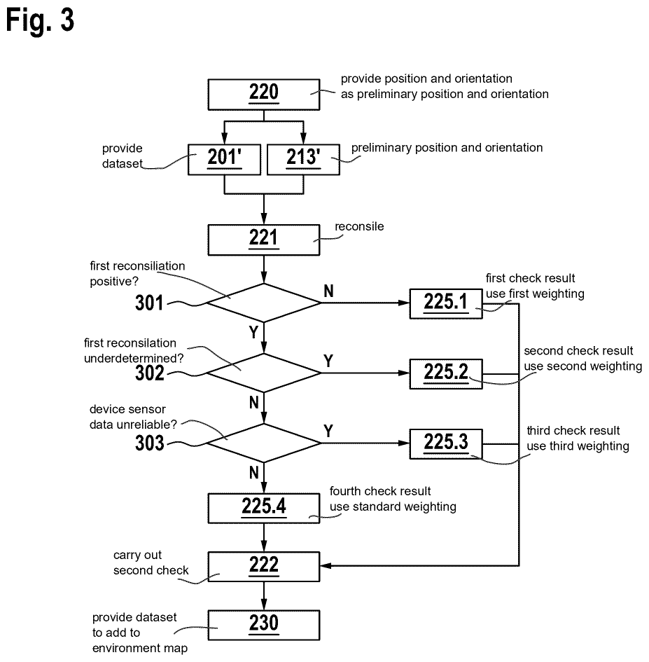

This is again explained in more detail below with reference to FIG. 3, i.e. which check result can be used when. Here, firstly step 220 of FIG. 2 is repeated, in which the current dataset 201′ with the preliminary pose 213′ is provided.

This is followed by the first check 221 or the first reconciliation. For example, a standard weight can be used in this process. In step 301, it is checked whether the first reconciliation is positive. For example, the check result should include the first check result 225.1 if the first reconciliation is negative (N). Then the first weighting is used, according to which, for example, at least part of the device information is weighted higher than in the first reconciliation.

If the first reconciliation is positive (Y), it can be checked in step 302, for example, whether the first reconciliation is underdetermined, i.e. whether, for example, a corridor has been detected. If this is the case (Y), the check result should include, for example, the second check result 225.2. Then the second weighting is used, according to which, for example, at least part of the device information is weighted than in the first reconciliation. For example, the first and second weightings can be identical.

If it is determined in step 302 that the first reconciliation is not underdetermined (N), it can be checked in step 303 whether the device sensor data have been determined to be unreliable. If this is the case (Y), the check result may include the third check result 225.3, for example. Then the third weighting is used, according to which, for example, at least part of the device information is weighted lower than in the first reconciliation. For example, the device sensor data are determined to be unreliable if the preliminary position and orientation are not consistent within specified tolerances with a position and orientation obtained as part of the first reconciliation.

If this is not the case according to step 303 (N), the check result should include the fourth check result 225.4, for example. The weighting used in the first reconciliation, i.e. the standard weighting, can be used here.

This is followed by the second check, step 222, with the second reconciliation, wherein the first, second, third, or fourth weighting is used depending on the situation.

The dataset 201 with the pose 213′″ provided in step 230 can then be added to an existing environment map 235 (step 232); in this case, the dataset 201 with the pose 213′″ can also be referred to as a so-called keyframe. This can only be done, for example, when an update criterion 231 is present. The update criterion can include, for example, that no dataset has been added to the environment map for a certain period of time, or that the mobile device has moved a certain distance since the last addition.

In the event that an error F occurred in the sequence described above, the dataset obtained may be erroneous. In this case, this can be used as an update criterion 231 to add the dataset obtained in the preceding sequence (localization process), in which in particular no error occurred, to the environment map 235.

Other update criteria for which the dataset obtained in the preceding sequence (localization process) is added to the environment map 235 may also be that the second reconciliation is negative, in particular if, in addition, the second reconciliation in the preceding localization process was positive; that the device sensor data have been determined to be unreliable, in particular if, in addition, the device sensor data in the preceding localization process have not been determined to be unreliable; if the first reconciliation is underdetermined, in particular if the first reconciliation in the preceding localization process was not underdetermined; that the mobile device was placed on a surface during the preceding localization process; or that the environmental sensor data were not obtained or provided, at least temporarily, during the localization process.

Adding the dataset provided in the preceding localization process, to the existing environment map or, in general, a dataset to the environment map, may in particular involve a specific check. This checks whether a difference between a position and orientation (pose) of the mobile device, determined on the basis of the device information, in the dataset being added and the position and orientation (pose) of the mobile device in a dataset most recently added to the environment map is within a specified tolerance.

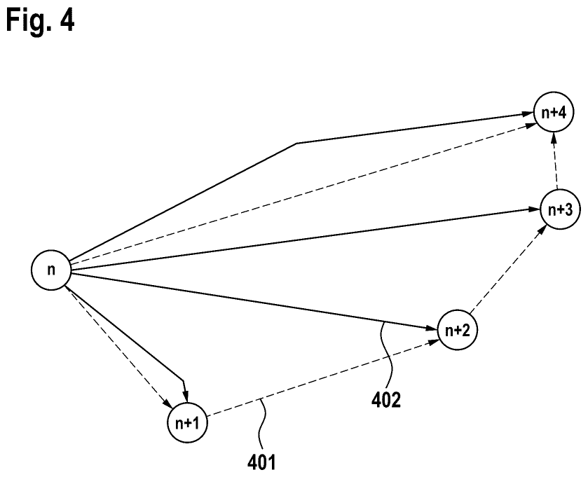

This is illustrated in FIG. 4. For this purpose, multiple localization processes n to n+4 are shown by way of example, each of which is based on environmental sensor data and the datasets obtained thereby. In addition, a pose can in each case be determined with the aid of the associated device information or device sensor data, as explained above. This is typically always done with respect to the most recently ascertained pose. For example, in the localization process n, a pose may have been determined according to the sequence mentioned above with two scan matches. For the localization process n+1, a pose relative to the pose of the localization process n is then determined on the basis of the current device information. This is indicated by the arrows 401 (dashed). With the pose ascertained in this way, the localization process n+1 can be carried out with, for example, the two scan matches. However, as mentioned above, the scan match itself is performed with the current dataset with respect to the dataset most recently added to the environment map. This is indicated by the arrows 402 (solid line).

For example, if the dataset of the localization process n is the most recently added dataset, the scan match will also be performed for the localization processes n+1, n+2, n+3 relative to the dataset of the localization process n, but the pose is always determined relative to the preceding localization process, i.e. for example, relative to the localization process n+2 in the case of the localization process n+3.

In this way, small deviations in the pose can add up. For this purpose, it is now proposed that if a dataset is to be added to the environment map, the pose should also be determined relative to the pose of the most recently added dataset. For example, if the dataset of the localization process n+4 is to be added, the pose will also be determined on the basis of the device information for the localization process n+4 relative to the localization process n. If there is too large a deviation here, this can be regarded as an error so that the current dataset of the localization process n+4 is not used, for example.

As already mentioned, FIG. 2 by way of example describes a localization process which in particular comprises providing the necessary data in step 200 up to providing a dataset 201′ in step 230, which may be added to the environment map. As has also been described, it is possible to check in various steps during the localization process whether there is an error F. This can be done not only for a single localization process but for every localization process.

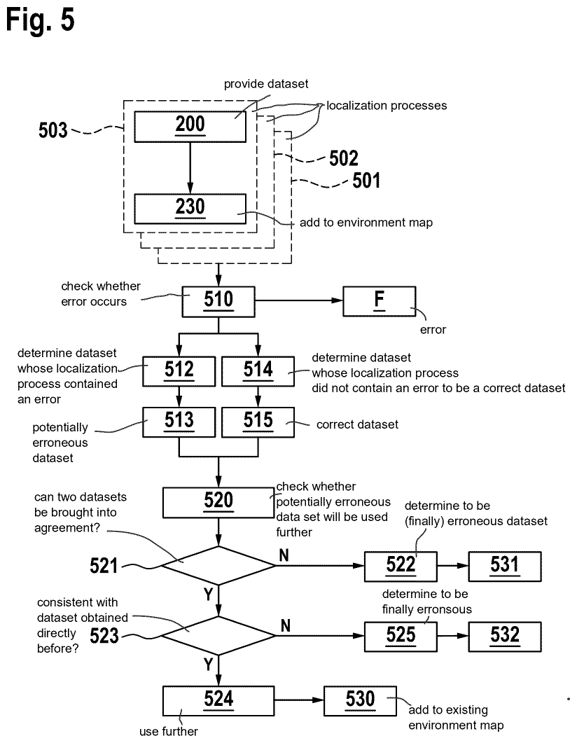

This is shown again in FIG. 5 in a highly simplified manner for a localization process 506. It is schematically shown that there are multiple localization processes, which are denoted by 501, 502, 503 by way of example.

In step 510, it is checked whether an error F occurs. If an error F occurs, in step 512, the dataset whose localization process contained an error is determined to be a potentially erroneous dataset 513. For example, this may be the case for the dataset in the localization process 502. A dataset whose localization process did not contain an error is determined, in step 514, to be a correct dataset 514. For example, this may be the case for the dataset in the localization processes 501 and 503.

Various error criteria can be provided, in the presence of which it is assumed or determined that an error has occurred in a localization process. In this way, sensor data of a sensor of the mobile device can be determined to be erroneous, for example. On the basis of the sensor data, it can be determined that the mobile device has been lifted (cf. the lift-up sensor mentioned above). On the basis of the sensor data, it can be determined that the mobile device has been moved by an external force, in particular horizontally. The difference between the position and/or orientation of the mobile device, determined on the basis of the device sensor data, in the correct dataset being added and a correct dataset most recently added to the environment map may not lie within a specified tolerance (as explained in more detail with respect to FIG. 4).

If a correct dataset is obtained after a potentially erroneous dataset, i.e. during the localization process 503 or at its end in the case mentioned, the potentially erroneous dataset is checked in step 520 to see whether it will be used further or not. In this way, it is noted that an error occurs or has occurred but further handling of the error is postponed to the end.

Checking the potentially erroneous dataset in step 520 comprises, for example, checking whether the correct dataset 515 (i.e. the one from the current localization process 503) can be brought into agreement with one or more correct datasets obtained before the potentially erroneous dataset or with an existing environment map according to at least one first reconciliation criterion in order to obtain a first check result. In this case, the check is preferably carried out with respect to the dataset from the localization process 501, which preceded the localization process 502 with the potentially erroneous dataset. For example, a scan match can be carried out here.

A first check result 521 is obtained, which indicates whether the two datasets can be brought into agreement. If the first check result 521 is negative (N), the potentially erroneous dataset 513 can be determined to be a (finally) erroneous dataset, step 522.

If the first check result 521 is positive (Y), it can be checked whether the potentially erroneous dataset is consistent with the dataset obtained directly before the potentially erroneous dataset, according to at least one second reconciliation criterion. If this is the case (Y), the potentially erroneous dataset can be determined to be a correct dataset, step 524. However, if this is not the case (N), the potentially erroneous dataset can be determined to be an erroneous dataset, step 525.

In the case according to step 524, the dataset can thus be used further as usual and, for example, added to the existing environment map as described above (cf. FIG. 2, step 232), here denoted by step 530. In other words, the reconciliation was successful here, and there was at most a small error in the pose estimation. This means that ultimately no (significant) error occurred and error prevention during the incremental localization was successful. It can be assumed that the pose estimates and the data assigned to potentially erroneous datasets are valid.

For the cases according to step 522 or 525, however, it can be provided that the then erroneous dataset is not used any further, but rather a new environment map can be created. This new environment map can then be combined with the existing environment map, for example. In the case according to step 525, i.e. that the first check result was positive, it can be assumed that the error was relatively small so that these environment maps can also be combined immediately since a sufficiently accurate reconciliation was available. The reconciliation was also successful here, but with a larger error in the pose estimation: an error occurred during the incremental localization, but the reconciliation for error detection was able to reconcile the last dataset with the environment map. This means that the incremental localization error most likely caused a relatively small error.

In the case according to step 522, i.e. that the first check result was negative, these environment maps can be combined later, for example, if more information is available to check whether or how these environment maps can be combined. So the reconciliation failed here. An error occurred during the incremental localization, and the error detection reconciliation was not able to reconcile the most recent data with the environment map. This happens, for example, if the error is serious or if the mobile device has explored a new part of the environment. The latter case means that the map does not contain any correct data at the location where the mobile device is located.

A recovery procedure can then be provided to ensure that the SLAM state returns to a valid state after an error. The following steps can be carried out for this purpose. Problematic datasets from the previous localization process are deleted, and the last (correct) dataset is moved into a new map. This results in two disjoint maps, both of which are consistent. The SLAM system reports the position of the mobile system with respect to this new map. This means that other map data are (temporarily) no longer available, ensuring that other modules of the system behave accordingly. Optionally, it can be provided that, if the error detection reconciliation was successful, the two maps are immediately merged (cf. step 525), wherein the pose estimate from the error detection reconciliation is used. The advantage of an explicit merge is that it can be undone if it later turns out to be wrong. A new environment map is created since it is not certain what the exact trajectory from the last correct dataset to the current dataset looks like. After the recovery procedure, the two maps can be merged again.

As already mentioned above, a correct dataset does not always have to be added to the existing environment map; it is rather the case that this can in particular only be done when at least one update criterion is present. This may include, for example, that the dataset obtained after the correct dataset was determined to be erroneous. Then the dataset most recently obtained and determined to be correct can be added. This may also include that, since the last time a correct dataset was added to the existing environment map, the mobile device has traveled a given distance, or a specified period of time has passed during which a predetermined number of correct datasets has been obtained.

The proposed approach thus makes various innovations possible. For example, a holistic approach is possible, i.e. many different types of problems or errors can be handled, which may appear at different stages of the overall algorithm and involve different sensor settings (in contrast to specialized approaches which can only handle a single problem).

The problems or errors can be forwarded to later processing stages and then taken into account there. Premature and suboptimal decisions can thus be avoided, in particular in cases where the correct response to a problem only becomes clearer later (in contrast to conventional approaches where a processing stage can only either silently return a potentially incorrect result or stop the sequence with a fatal error). Nevertheless, it may also be provided, for example, that an attempt be made to continue the regular localization process or the navigation despite problems or errors.

Global map data can also be used. The final decision as to whether the incremental localization (localization process) has failed is based on global map data (environment map). It is postponed until unproblematic data (correct datasets) are available again for the incremental localization, and erroneous data are removed from the map or not incorporated in the first place. This mechanism allows SLAM to continue in extreme situations and allows for riskier error avoidance schemes where conventional approaches with a serious error are aborted or risk corrupting the environment map.

1-15. (canceled)

16. A method for error handling during navigation of a mobile device, wherein the mobile device moves or is intended to move in an environment, while using SLAM-based localization, the method comprising the following steps:
repeatedly carrying out localization processes, wherein each of the localization processes includes:
providing device and environmental information, which has been acquired from the device and/or the environment at least in part by sensors of the mobile device,
creating a dataset based on the device and environmental information, and
providing the dataset for use for the localization and/or navigation of the mobile device;
checking, during each of the localization processes, whether there is an error;
determining each dataset of the provided datasets whose localization process contained an error to be a potentially erroneous dataset;
determining each dataset of the provided datasets whose localization process did not contain an error to be a correct dataset; and
when a correct dataset is obtained after a potentially erroneous dataset is obtained: checking the potentially erroneous dataset to see whether the potentially erroneous dataset will be used further or not.

17. The method according to claim 16, wherein the mobile device is an at least partially automated vehicle or robot.

18. The method according to claim 16, wherein the mobile device is a cleaning robot or a robot lawn mower

19. The method according to claim 16, wherein the checking of the potentially erroneous dataset includes: checking whether the correct dataset can be brought into agreement with one or more correct datasets obtained before the potentially erroneous dataset or with an existing environment map according to at least one first reconciliation criterion in order to obtain a first check result.

20. The method according to claim 19, wherein, when the first check result is negative: determining the potentially erroneous dataset to be an erroneous dataset.

21. The method according to claim 19, wherein the device and environmental information include device information, including device sensor data, which have been acquired by sensors of the mobile device, wherein the device information includes information about a position and/or movement of the mobile device, wherein the device and environmental information includes environmental sensor data, which have been acquired from the environment by sensors of the mobile device, and the method further comprises:
further comprising, when the first check result is positive:
when the potentially erroneous dataset is consistent with a dataset obtained directly before the potentially erroneous dataset, according to at least one second reconciliation criterion: determining the potentially erroneous dataset to be a correct dataset.

22. The method according to claim 21, furthermore comprising, when the potentially erroneous dataset is not consistent with the dataset obtained directly before the potentially erroneous dataset, according to the at least one second reconciliation criterion:
determining the potentially erroneous dataset to be an erroneous dataset.

23. The method according to claim 20, further comprising:
creating a new environment map based on a correct dataset obtained after the dataset determined to be erroneous.

24. The method according to claim 23, further comprising:
combining the new environment map with an existing environment map, wherein the erroneous dataset is not used.

25. The method according to claim 16, further comprising:
adding those of the provided datasets determined to be correct datasets to an existing environment map when at least one update criterion is present,
wherein the at least one update criterion includes at least one of the following update criteria:
a dataset obtained after the correct dataset was determined to be erroneous,
the mobile device has traveled a given distance since the last time a correct dataset was added to the existing environment map,
a prespecified period of time has passed since the last time a correct dataset was added to the existing environment map,
a predetermined number of correct datasets has been obtained since the last time a correct dataset was added to the existing environment map.

26. The method according to claim 21, wherein it is determined that an error has occurred during a localization process of the localization processes when at least one of the following error criteria is met:
sensor data of a sensor of the mobile device are determined to be erroneous,
based on the sensor data, it is determined that the mobile device has been lifted,
based on the sensor data, it is determined that the mobile device has been moved by an external force horizontally, and
when a difference between the position and/or orientation of the mobile device, determined based on the device sensor data, in the correct dataset is added and a correct dataset most recently added to the environment map does not lie within a prespecified tolerance.

27. The method according to claim 16, further comprising:
determining navigation information for the mobile device, based on correct datasets of the provided datasets.

28. A system, comprising:
a data processor configured for error handling during navigation of a mobile device, wherein the mobile device moves or is intended to move in an environment, while using SLAM-based localization, the data processor configured to perform the following steps including:
repeatedly carrying out localization processes, wherein each of the localization processes includes:
providing device and environmental information, which has been acquired from the device and/or the environment at least in part by sensors of the mobile device,
creating a dataset based on the device and environmental information, and
providing the dataset for use for the localization and/or navigation of the mobile device;
checking, during each of the localization processes, whether there is an error;
determining a dataset of the provided datasets whose localization process contained an error to be a potentially erroneous dataset;
determining a dataset of the provided datasets whose localization process did not contain an error to be a correct dataset; and
when a correct dataset is obtained after a potentially erroneous dataset is obtained: checking the potentially erroneous dataset to see whether the potentially erroneous dataset will be used further or not.

29. The method according to claim 27, wherein the mobile device includes an open-loop or closed-loop control unit and a drive unit for moving the mobile device according to the navigation information.

30. A mobile device, comprising:
a system including a data processor configured for error handling during navigation of a mobile device, wherein the mobile device moves or is intended to move in an environment, while using SLAM-based localization, the data processor configured to perform the following steps including:
repeatedly carrying out localization processes, wherein each of the localization processes includes:
providing device and environmental information, which has been acquired from the device and/or the environment at least in part by sensors of the mobile device,
creating a dataset based on the device and environmental information, and
providing the dataset for use for the localization and/or navigation of the mobile device,
checking, during each of the localization processes, whether there is an error,
determining a dataset of the provided datasets whose localization process contained an error to be a potentially erroneous dataset,
determining a dataset of the provided datasets whose localization process did not contain an error to be a correct dataset, and
when a correct dataset is obtained after a potentially erroneous dataset is obtained: checking the potentially erroneous dataset to see whether the potentially erroneous dataset will be used further or not;
wherein the mobile device is an at least partially automated vehicle, including: (i) a passenger transport vehicle or (ii) a goods transport vehicle or (iii) a robot or (iv) a household robot or (v) a cleaning robot or (vi) a floor-or street-cleaning device or (vii) a robot lawn mower or (viii) a drone.

31. A non-transitory computer-readable storage medium on which is stored a computer program for error handling during navigation of a mobile device, wherein the mobile device moves or is intended to move in an environment, while using SLAM-based localization, the computer program, when executed by a computer, causing the computer to perform the following steps comprising:
repeatedly carrying out localization processes, wherein each of the localization processes includes:
providing device and environmental information, which has been acquired from the device and/or the environment at least in part by sensors of the mobile device,
creating a dataset based on the device and environmental information, and
providing the dataset for use for the localization and/or navigation of the mobile device;
checking, during each of the localization processes, whether there is an error;
determining a dataset of the provided datasets whose localization process contained an error to be a potentially erroneous dataset;
determining a dataset of the provided datasets whose localization process did not contain an error to be a correct dataset; and
when a correct dataset is obtained after a potentially erroneous dataset is obtained: checking the potentially erroneous dataset to see whether the potentially erroneous dataset will be used further or not.
